(19) United States
(12) Patent Application Publication
(10) Pub. No.: US 2026/0059272 A1
(43) Pub. Date: Feb. 26, 2026

(54) Methods and Apparatus for Handling Sensing of an Object

(71) Applicant: Telefonaktiebolaget LM Ericsson (publ), Stockholm (SE)

(72) Inventors: Ali Behravan, Stockholm (SE); Robert Baldemair, Solna (SE); Stefan Parkvall, Bromma (SE); Erik Dahlman, Stockholm (SE); Håkan Björkegren, Täby (SE)

(21) Appl. No.: 18/707,721

(22) PCT Filed: Nov. 8, 2021
(86) PCT No.: PCT/SE2021/051117

§ 371 Date: May 6, 2024

(51) Int. Cl. H04W 4/38; G01S 13/00

(52) U.S. Cl. CPC H04W 4/38; G01S 13/003

(57) ABSTRACT

The disclosure relates to methods and nodes for handling sensing of an object in an environment served by a wireless communication network employing joint communication and sensing. A method (1000) by a first radio node comprises transmitting (1002) a first signal having a first parameter setting for detecting a property of the object using sensing and. upon reception of information on a delayed and/or distorted version of the first signal either transmitting (1005) a second signal having a second parameter setting for determining properties of the object using sensing or reporting (1006) information on the property of the object to a further node that causes transmission of the second signal having the second parameter setting for determining the properties of the object in the environment using sensing. The second parameter setting provides for sensing at higher resolution, in a wider range and/or with higher reliability than the first parameter setting.

### TECHNICAL FIELD

The present disclosure relates to methods and communication nodes for handling sensing of an object in an environment served by a wireless communication network employing joint communication and sensing.

### BACKGROUND

Joint communication and sensing (JCAS) is emerging as one of the main use cases in future wireless cellular communications such as 6G. The idea is to use cellular communication nodes (base stations/UEs) to sense the environment by either using the communication-specific signals or dedicated sensing signal, and provide information such as location, shape, speed, etc of the objects in the surrounding. Some of the possible applications of sensing using cellular communication systems are traffic monitoring and crash avoidance, gesture/motion detection, presence detection of objects or persons, vital sign detection, environment mapping, particle/pollution detection, etc.

Sensing can be done either using a single node, i.e. the transmitter and receiver are co-located, which means that the sensing is mono-static, or using multiple nodes, i.e. the transmitter and receiver(s) are in different locations, which means that the sensing is multi-static. FIG. 1 provides an example (a) of a mono-static sensing scenario and another example (b) of a bi-static sensing scenario, which is a case where two different nodes are used so that the transmitter and receiver(s) are in different locations. One particular challenge with the mono-static scenario in joint communications and sensing is that if the same radio node is used for simultaneous transmission and reception, then it has to be capable of full-duplex communication. This is particularly challenging since the received signal levels in cellular communications are lower than the transmitted signals by several orders of magnitude which makes reception of such signals practically impossible unless certain designs are considered to reduce interference. In a mono-static radar or sensing setup simultaneous transmission and reception, and thus full duplex, is unavoidable if it should be possible to detect targets, e.g. objects, close to the base stations. Targets far enough away are less challenging from this point of view since the echo arrives after the base station (BS) stopped transmitting.

On the other hand, multi-static scenario is more aligned with the conventional cellular communication systems in the sense that it does not require simultaneous transmission and reception from the same node. However one challenge in using communication nodes in multi-static scenario is that the neighbouring nodes must be in different duplex directions, uplink and downlink, which means that different time division duplex (TDD) configurations in the two cells must be used. This is also rather challenging since using different TDD configurations in neighbouring cells can give rise to large intercell interference, especially from the downlink transmission in one cell to the uplink reception in the other cell.

### Sensing Signal Processing

In active sensing, a signal is transmitted to probe the environment and the received reflections are used to estimate position/speed of the objects in the range. Depending on the required accuracy and range for the position and speed of the object, there are certain requirements on the duration, bandwidth, and periodicity of the signal to be used.

In a typical pulse radar a sequence of signatures or spreading codes with chip duration T and signal integration duration of Tᵢₙₜ with periodicity Tᵣ are transmitted for a duration T_{f} as shown in FIG. 2, presenting an illustration of sequence of spreading codes used in pulse radar. The choice of these parameters determine unambiguous range (sensing range, if signatures are identical), range resolution, unambiguous velocity (velocity range), and velocity resolution for sensing targets.

Depending on the use case, a sensing signal design must be tailored to meet the fundamental requirements on:
Range resolution (Rr): minimum distinguishable distance between two objects.
Unambiguous range (Ru): maximum distance where an object can be located for guaranteed detection.
Velocity range (vu): maximum range of velocity of moving object that can be measured.
Velocity resolution (vr): smallest change in the velocity of the moving object that can be measured.

The parameters of a sensing signal including a minimum bandwidth, a minimum duration of sensing signal, a minimum and maximum repetition periodicity, and a minimum duration of the sensing frame, must be designed such that the above sensing requirements are met. The table below shows the relationship between the sensing requirements and the sensing signal parameters.

| | |
|---|---|
| Required bandwidth | BWₘᵢₙ = c/2Rᵣ |
| Minimum gap between sensing signals | T_{r min} = 2Rᵤ/c |
| Maximum gap between sensing signals | T_{r max} = c/4f_{c}vᵤ |
| Required sensing frame duration | T_{f} = c/2f_{c}vᵣ |

At the receiver, the reflected signal from the surrounding is received and is matched filtered with the transmitted waveform to give the delay (distance of the object), as well as the phase rotation between consecutive waveforms to give the doppler shift due to the movement of the object. In principle the above-mentioned signal generation and receiver processing is common to all types of sensing methods and signals, and is not limited to a pulse radar. In a joint communication and sensing scenario the choice of waveform may depend on what waveform is more suitable for both communication and sensing, although this is not a requirement, and the waveforms for the two systems can be different. The following description of receiver processing is independent of the waveform type and is equally applicable to waveforms as shown in FIG. 2 as well as any typical communication waveform such as OFDM, etc. As one example the waveform can be one or several orthogonal frequency-division multiplexing (OFDM) or Direct Fourier Transform spread-orthogonal frequency-division multiplexing (DFTS-OFDM) symbols (or even sub-symbols), as it is the common waveform used in most of the existing wireless access links. FIG. 3 shows a sensing signal based on OFDM symbols in form of a train of OFDM symbols as the sensing signal.

A common receiver processing is to perform a fast Fourier transform (FFT) per sequence occurrence, transforming delay domain into subcarrier (frequency) domain, and an Inverse Fast Fourier Transform (IFFT) per subcarrier across the sequence occurrences, transforming time-domain into Doppler domain. Then all peaks beyond a threshold are identified and the delay and Doppler values associated with each peak, representing the target, correspond to delay and velocity of the target.

As mentioned earlier, the accuracy and range of sensing is directly related to the duration, bandwidth, periodicity and frame size of the sensing signals. To achieve a certain sensing accuracy or range, a large part of time-frequency resources must be used for sending and receiving the sensing signal. This results in a large overhead for the communication network.

### SUMMARY

It is an object of embodiments described herein to address at least some of the problems and issues outlined above. More particularly it is an object to provide methods and nodes to perform multi-stage sensing, also denoted hierarchical sensing, to reduce sensing signal overhead, increase the sensing accuracy and enable adjustment of angular and radial coverage of the sensing signal.

A first aspect of the disclosed technology relates to a method performed by a first radio node for handling sensing of an object in an environment served by a wireless communication network employing joint communication and sensing. In the method, the first radio node transmits a first signal having a first parameter setting for detecting a property of the object in the environment using sensing. Upon reception of information on a delayed and/or distorted version of the first signal, the first radio node may either transmit a second signal having a second parameter setting for determining one or more properties of the object in the environment using sensing or the first radio node may report information on the property of the object in the environment to a further node to provide for the further node to cause transmission of the second signal having the second parameter setting for determining the one or more properties of the object in the environment using sensing. In the method, the second parameter setting applied for the second signal provides for sensing at a higher resolution and/or in a wider range and/or with higher reliability than the first parameter setting applied for the first signal.

A second aspect of the disclosed technology relates to a method performed by a further node for handling sensing of an object in an environment served by a wireless communication network employing joint communication and sensing. In the method, the further node receives a report of information on a property of the object in the environment, the information on the property being obtained using sensing, the sensing including a first radio node transmitting a first signal having a first parameter setting for detecting the property of the object in the environment. Upon detection of the property of the object in the environment, the further node causes transmission of a second signal having a second parameter setting for determining one or more properties of the object in the environment using sensing. In the method, the second parameter setting applied for the second signal provides for sensing at a higher resolution and/or in a wider range and/or with higher reliability than the first parameter setting applied for the first signal.

A third aspect of the disclosed technology relates to a first radio node for handling sensing of an object in an environment served by a wireless communication network employing joint communication and sensing. The first radio node is configured to transmit a first signal having a first parameter setting for detecting a property of the object in the environment using sensing. Upon reception of information on a delayed and/or distorted version of the first signal, the first radio node is further configured to either transmit a second signal having a second parameter setting for determining one or more properties of the object in the environment using sensing or report information on the property of the object in the environment to a further node to provide for the further node to cause transmission of the second signal having the second parameter setting for determining the one or more properties of the object in the environment using sensing. The first radio node is configured to apply the second parameter setting for the second signal in order to provide for sensing at a higher resolution and/or in a wider range and/or with higher reliability than obtainable with the first parameter setting applied for the first signal.

A fourth aspect of the disclosed technology relates to a further node for handling sensing of an object in an environment served by a wireless communication network employing joint communication and sensing. The further node is configured to receive a report of information on a property of the object in the environment, the information on the property being obtained using sensing, the sensing including a first radio node transmitting a first signal having a first parameter setting for detecting the property of the object in the environment. The further node is further configured to, upon detection of the property of the object in the environment, cause transmission of a second signal having a second parameter setting for determining one or more properties of the object in the environment using sensing. The second parameter setting applied for the second signal is adapted to provide for sensing at a higher resolution and/or in a wider range and/or with higher reliability than the first parameter setting applied for the first signal.

Certain embodiments may provide one or more of the following technical advantages. One technical advantage of embodiments may be that they provide solutions that reduce sensing signal overhead in a joint communication and sensing wireless communication network. Another technical advantage of embodiments may be that they allow for tradeoff between sensing signal overhead and sensing accuracy or range. Furthermore, in situations when there is no object to be sensed, then there is no need to have a dense sensing signal, and an advantage of embodiments may be that a less resource-intensive signaling can be used to detect the presence or a rough estimate of the shape, before attempting a more accurate sensing.

These and other objects, features and advantages of the exemplary embodiments of the present disclosure will become apparent upon reading the following detailed description of the exemplary embodiments of the present disclosure.

### BRIEF DESCRIPTION OF THE DRAWINGS

Some embodiments of the disclosed technology are described below with reference to the accompanying drawings which are by way of example only and in which:

FIG. 1 schematically illustrates (a) a mono-static sensing scenario and (b) a bi-static sensing scenario;

FIG. 2 is a schematic illustration of sequence of spreading codes used in pulse radar;

FIG. 3 is a schematic illustration of a train of OFDM symbols as sensing signal;

FIG. 4 is an example of multi-stage sensing with different bandwidths

FIG. 5 is another example of multi-stage sensing with different bandwidths

FIGS. 6-7 are signalling diagrams schematically illustrating embodiments of the disclosed technology;

FIG. 8 is a flow diagram schematically illustrating an example of a method performed by a first radio node according to some embodiments of the disclosed technology;

FIG. 9 is a flow diagram schematically illustrating another example of the method performed by the first radio node according to some embodiments of the disclosed technology;

FIG. 10 is a flow diagram schematically illustrating an example of a method performed by a further node according to some embodiments of the disclosed technology;

FIG. 11 is a block diagram schematically illustrating the first radio node according to some embodiments of the disclosed technology;

FIG. 12 is a block diagram schematically illustrating the further node according to some embodiments of the disclosed technology;

FIG. 13 is a block diagram illustrating an exemplary wireless communication network according to various embodiments of the present disclosure;

FIG. 14 is a block diagram illustrating an exemplary network node according to various embodiments of the present disclosure;

FIG. 15 is a block diagram illustrating an exemplary wireless device according to various embodiments of the present disclosure;

FIGS. 16-17 are block diagrams of exemplary communication systems and/or networks, according to various exemplary embodiments of the present disclosure.

FIGS. 18-21 are flow diagrams illustrating exemplary methods and/or procedures implemented in a communication system, according to various exemplary embodiments of the present disclosure.

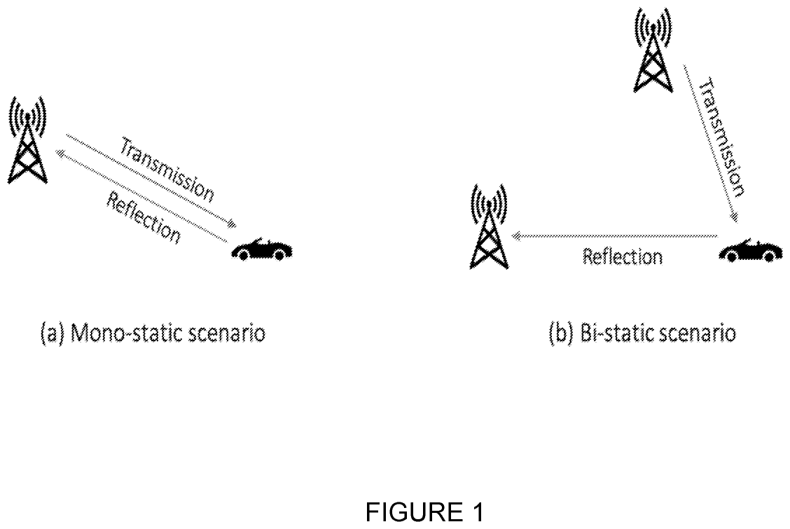

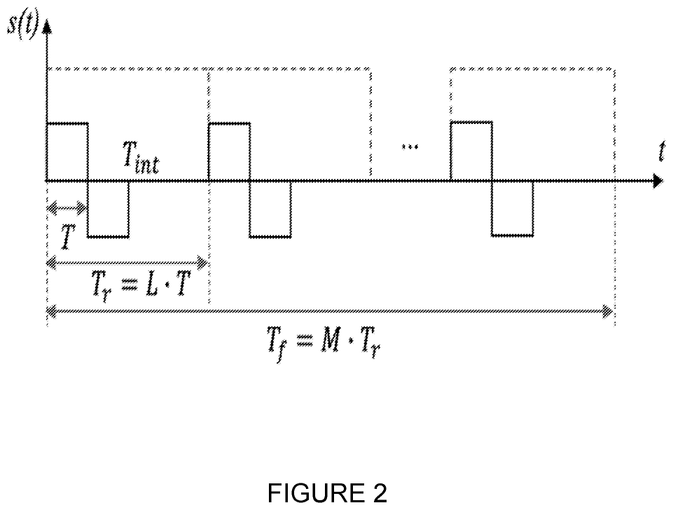

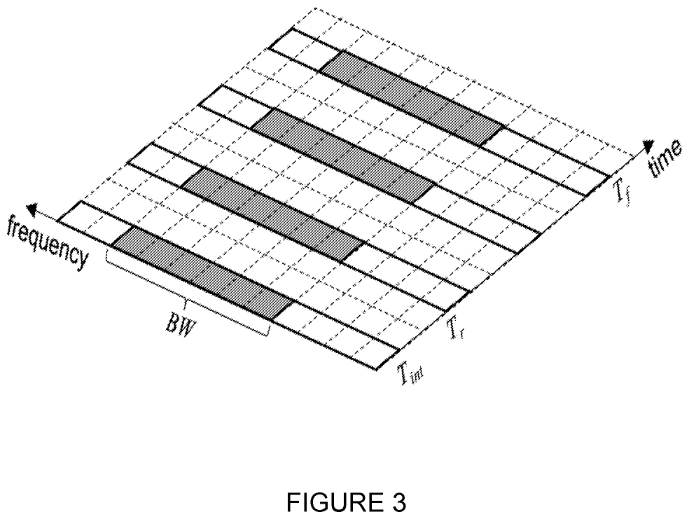

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein.

In joint communication and sensing, the transmission and reception points may be user equipments (UEs) or base stations, meaning that the communication can be in downlink (DL), uplink (UL), UE to UE, or base station to base station. In the context of existing cellular communications such as 5G, this could mean that the sensing signal can be a DL reference signal, or a UL reference signal, or a sidelink reference signal. Also, the sensing signal can be any of the existing signals, such as DL positioning reference signal (PRS), Channel State Information Reference Signal (CSI-RS), Demodulation Reference Signal (DM-RS) and UL sounding reference signal (SRS), etc, or a new sensing/positioning specific signal.

As exemplified in the above, sensing is a technique whereby it is possible to detect or determine properties or characteristics of an object by transmitting a radio signal towards the object in a surrounding or environment and receive and/or perform measurements upon a delayed and/or distorted version of the transmitted signal. The delayed and/or distorted version of the transmitted signal may be a (direct) reflection of the transmitted signal received or measured upon by the node that transmitted the signal, or a multi-path or line-of-sight (LOS) version received by another radio node. The transmitted signal may be distorted in that e.g. its amplitude and/or phase is changed compared to the amplitude and/or phase it had at the transmission.

By processing the received version of the transmitted signal and/or the performed measurements, information about the object, e.g. properties or characteristics such as presence, location, shape, speed, movement, size, etc., can be detected or determined. Depending on the configuration, e.g. in form of a parameter setting, of the transmitted signal, the detected or determined information about the object may be a rough estimate or a more reliable determination having a certain reliability, accuracy or range of sensing.

The transmitted signal, such as the first and second signals in this disclosure, may comprise a single signal or a train of more than one or multiple signals and it may be transmitted at one or more than one occasion. The signal may be transmitted periodically, i.e. the transmit occasions may have a periodicity, and each occasion may have a time duration. Within a transmit occasion, the train of more than one or multiple signals transmitted during the time duration of the transmit occasion, may also have a periodicity, i.e. they may be transmitted with a time interval in-between them. The time interval, and thus the periodicity, may be fixed or variable within the transmit occasion.

As stated above, this disclosure provides methods to perform multi-stage sensing, or hierarchical sensing to reduce sensing signal overhead, and increase the sensing accuracy or range as well as to adjust angular and radial coverage. More specifically the following hierarchical or multi-stage sensing possibilities are disclosed:
Method of sending sensing signals with different bandwidth, e.g. first sending one or more sensing signals with low bandwidth for a rough estimation of e.g. the location and then sending one or more sensing signals with increased the bandwidth for fine-tuning and increasing the sensing accuracy with respect to range.
Method of sending sensing signals with different beamwidth, e.g. first sending one or more sensing signals with a wide beam for a rough estimation of the location/speed/trajectory or to be able to sense more objects in the range and then narrowing the beam of one or more sensing signals for fine-tuning and increasing the sensing accuracy.
Method of hierarchical sensing using a combination of different signals. For example sensing might be done using downlink synchronization and downlink positioning reference signal, etc.
Method of hierarchical sensing using a combination of DL and UL. In this case different nodes may be cooperating by performing e.g. rough sensing based on DL PRS and more accurate sensing based on UL SRS.

In summary, various methods to perform multi-stage (hierarchical) sensing are provided. The sensing is hierarchical or multi-stage in that the sensing may start as a rough sensing e.g. covering a wide area or surrounding using a small amount of resources and then stage-wise in one or more stages be refined by using a relatively high amount of resources in a more precisely defined area or surrounding. The multi-stage sensing can be used to reduce sensing signal overhead, increase the sensing accuracy, or adjust angular and radial coverage of the sensing solution.

In more detail, the above examples concern:

### Multi-Stage Sensing with Varying Bandwidth

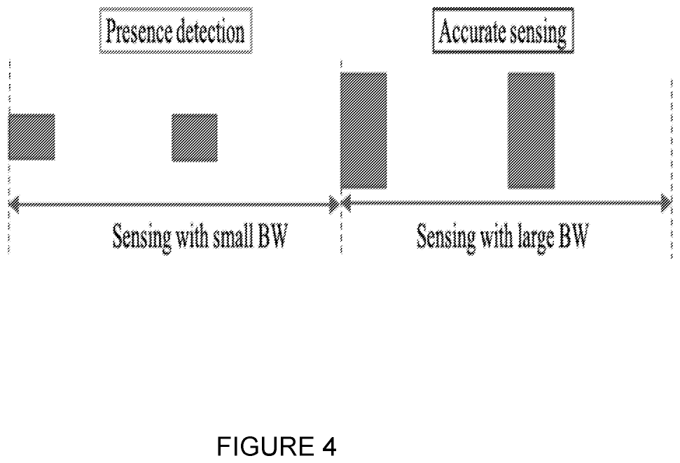

According to this method, sensing signals with different bandwidths are used in different stages of sensing. As one example, for a rough sensing of the environment, and to reduce the sensing signal overhead, a signal with low bandwidth is transmitted, and if an object is sensed, then a sensing signal with larger bandwidth is transmitted to get a more accurate estimate of location, as illustrated in FIG. 4.

An extension of the idea is that the adaptation from a rough sensing to a more accurate sensing is based on a detailed analysis of the detected object. As one example moving from rough detection to a more accurate detection can depend on.
Whether an object is detected at closer or further range
Whether the object moving slow or fast.
Whether the detection can be done accurately enough (if amplitude peak is detected with enough threshold above noise floor)

Alternatively, other means to control the bandwidth such as different combs can be used. For example a sensing signal with a more sparse comb is transmitted first for a rough sensing followed—once a target is detected—by sensing signal with a denser comb for more accurate sensing. The sparse comb leads to a shorter periodicity of the time-domain signal and thus a shorter unambiguous range (at the advantage of lower overhead). Once an object is detected, a narrower comb (longer periodicity and thus longer unambiguous range) is transmitted for improved location determination.

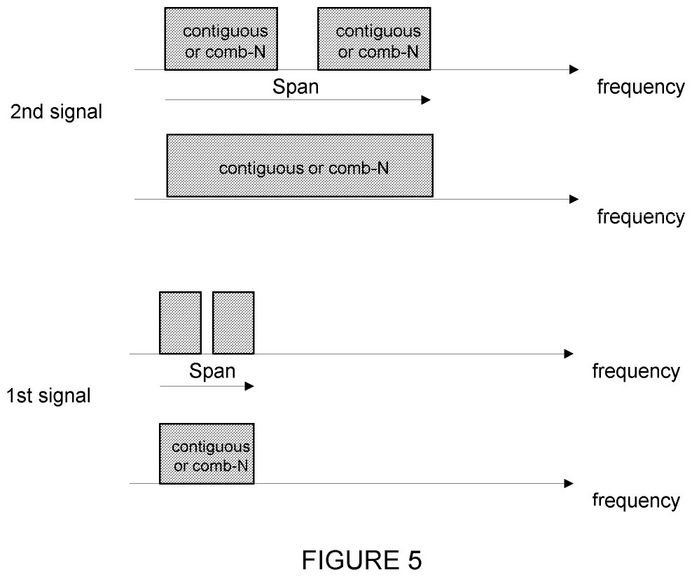

FIG. 5 illustrates an example seeking to explain the concept of the comb. Two examples of a first signal and two examples of a second signal are shown. The two examples of the second signal span a larger bandwidth than the two examples of the first signal. In one example of the first and the second signals, the blocks of frequency resources are interrupted by a space, which in this example is more narrow for the first signal than for the second signal, meaning that in this example, the comb is denser for the first signal spanning the smaller bandwidth and more sparse for the second signal spanning the larger bandwidth. In addition to this comb concept, each of the illustrated frequency resource blocks may in a conventional way be contiguous or have a comb-N within the respective frequency resource block.

### Multi-Stage Sensing with Varying Beamwidth

According to this method, sensing signals with different beamwidths are used in different stages of sensing. As one example, a wide beam is used in the first step of sensing to get a rough sensing of the environment or detect the presence of the target. In the second steps and following the detection of a target, the second beam that is more narrow can be used for a more accurate estimation of location/speed/trajectory of the target.

Using a wider beam can result in a reduction of overhead since a wider beam is capable of scanning a wider area and possibly detecting more objects in the range. Therefore the entire sensing region can be sensed with a small number of wide beams rather than using a large number of narrow beams.

Alternatively, and to add another degree of freedom to the solution, the sensing signal with different beamwidths can have different time duration as well. For example a transmission of sensing signal with wide beam can have a shorter duration in time while the narrower beam can be with longer duration in time, or vice versa.

### Multi-Stage Sensing with Different Reference Signals

According to this method, a combination of different signals, e.g. reference signals, can be used for sensing. As one example, and to reduce sensing signal overhead, downlink synchronization signal is used primarily for rough sensing or presence detection, while a dedicated sensing signal that can also be tailored for the estimated location/speed/trajectory is used for a more accurate sensing.

Another alternative for the first stage of sensing is to use CSI-RS for sensing and combine that with ZP-CSI-RS, i.e. zero power CSI-RS, to create a “listening possibility”. If something is detected in the first stage then the more detailed stage 2 sensing is activated or triggered.

### Multi-Stage Sensing Involving Different Duplex Directions

Another embodiment of the invention is using combination of DL and UL signals for accurate sensing. In this case, the first stage may be a rough presence detection based on a reference signal in one duplex direction (DL or UL), and the following more accurate sensing is based on another reference signal which is on another duplex direction (UL or DL). The reason for such scenario could be that certain reference signals are sent less frequently and/or over smaller BW, while on the other duplex direction maybe there is no such limitation.

In one alternative scenario different nodes may be cooperating by performing e.g. rough sensing based on DL synchronization signal, followed by a more accurate sensing based on UL sounding reference signal.

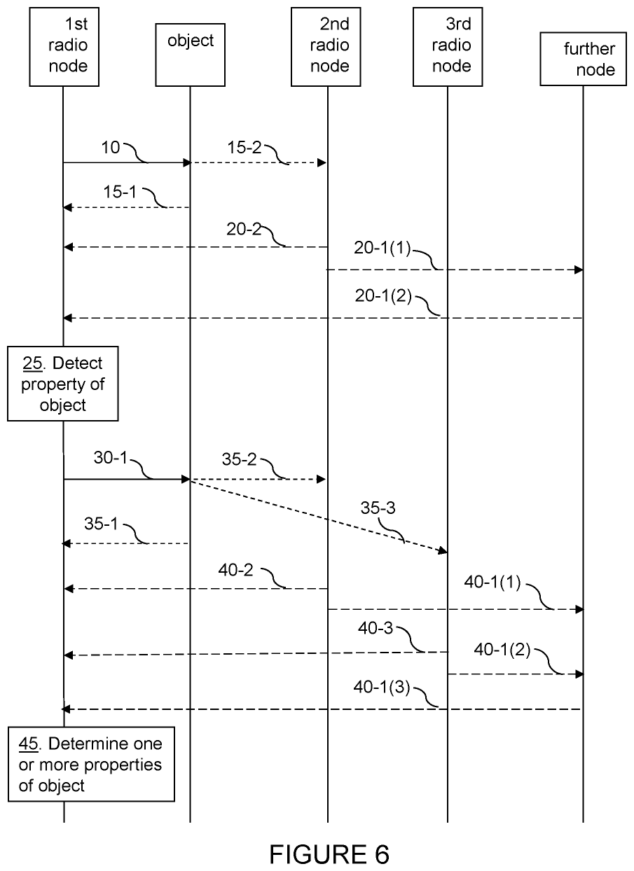

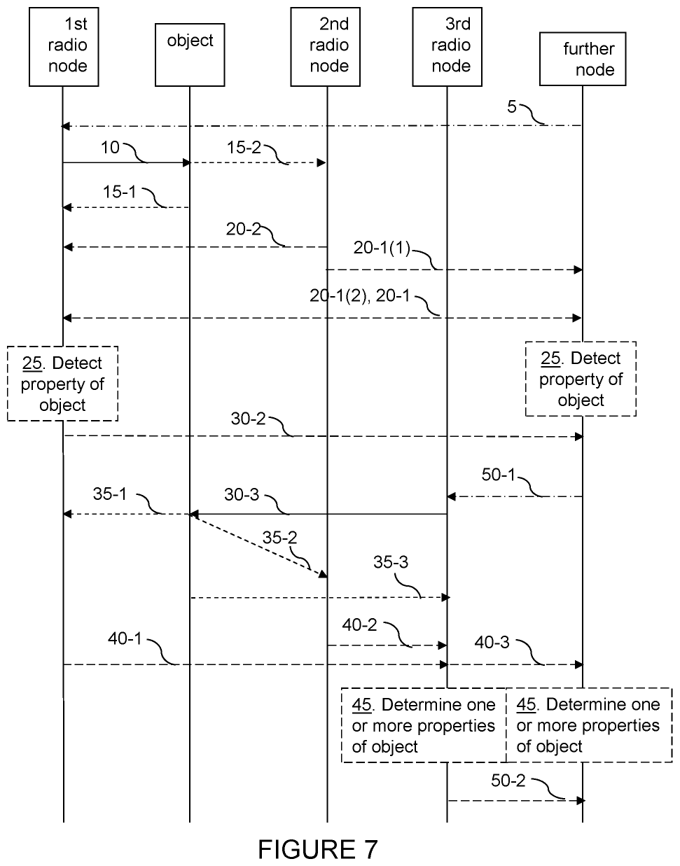

FIGS. 6 and 7 illustrate, in form of signalling diagrams, various possible interactions in the sensing of an object according to the teachings herein. The sensing involves a set of radio nodes, exemplified by first (1^{st}), second (2^{nd}) and third (3^{rd}) radio nodes, and a further node. The further node may be a physical node, such a network node having access to radio capability, e.g. by being a base station or by being connected to a base station in the wireless communication network, or a logical node located anywhere in the wireless communication network, or even in a wider communication system, e.g. at a host computer in the communication system. It may also be one of the radio nodes in the set of radio nodes. In one example, it may be the radio node that transmits at least one of the first and second signals for the sensing, such as the first radio node in FIG. 6 or the third radio node in FIG. 7. The radio nodes, including the first (1^{st}), second (2^{nd}) and third (3^{rd}) radio nodes, may be any node having capability of transmitting and/or receiving radio signalling, such as a radio network node, e.g. a base station, or a wireless device or user equipment (UE). See also further definition of radio node further down below, where further examples are given.

In FIG. 6, a first radio node transmits a first signal 10 having a first parameter setting for detecting a property, such as presence or movement, of the object in the environment using sensing. The first radio node may then receive a delayed and/or distorted version 15-1 of the first signal. Additionally or alternatively, a second radio node may receive a delayed and/or distorted version 15-2 of the first signal. The delayed and/or distorted version 15-2 of the first signal received by the second radio node may be different from the delayed and/or distorted version 15-1 of the first signal received by the first radio node, i.e. they may be denoted first and second versions of the delayed and/or distorted first signal respectively. The first node may then receive a report 20-2 of reception of the delayed and/or distorted version 15-2 of the first signal from the second radio node. Alternatively, the second radio node may report 20-1(1) the reception of the delayed and/or distorted version 15-2 of the first signal at the second radio node to or via a further node, possibly via one of the radio nodes to which the further node is connected e.g. via wire. The further node may process reported delayed and/or distorted versions of the first signal at different ones of the radio nodes and send, possibly via one of the radio nodes, a report 20-1(2) to be received at the first radio node. The reports may contain information such as raw data or processed data from measurements on and/or processing of the delayed and/or distorted versions of the first signal. In this way the first radio node may receive information on delayed and/or distorted versions of the first signal by receiving the delayed and/or distorted version 15-1 as well as by receiving reports on reception of delayed and/or distorted versions at other radio nodes, such as the second radio node. Based on the transmitted first signal 10 and the received delayed and/or distorted version 15-1 of the first signal and/or the received reports 20-2 or 20-1(2), the first radio node may then detect 25 the property of the object in the environment. For example, it may be detected, e.g. by a rough estimate of location and/or velocity, that the object is present and/or moving in the environment.

Then, upon reception of information on a delayed and/or distorted version of the first signal and/or detection of the property of the object, the first radio node transmits a second signal 30-1 having a second parameter setting for determining one or more properties of the object in the environment using sensing. The one or more properties may or may not include the property detected with the first signal. The first radio node may then receive a delayed and/or distorted version 35-1 of the second signal. Additionally or alternatively, the second radio node may receive a delayed and/or distorted version 35-2 of the second signal and/or a third radio node may receive a delayed and/or distorted version 35-3 of the second signal. The delayed and/or distorted versions of the second signal received by the first, second and/or third radio nodes may be different from each other, i.e. they may be denoted first, second and third versions of the delayed and/or distorted second signal respectively. The first node may then receive a report 40-2 of reception of the delayed and/or distorted version 35-2 of the second signal from the second radio node and/or a report 40-3 of reception of the delayed and/or distorted version 35-3 of the second signal from the third radio node. Alternatively, the second radio node may report 40-1(1) the reception of the delayed and/or distorted version 35-2 of the second signal at the second radio node to or via the further node and/or the third radio node may report 40-1(2) the reception of the delayed and/or distorted version 35-3 of the second signal at the third radio node to or via the further node, in both cases possibly via one of the radio nodes to which the further node is connected e.g. via wire. The further node may process reported delayed and/or distorted versions of the second signal received at different ones of the radio nodes and send, possibly via one of the radio nodes to which the further node is connected e.g. via wire, a report 40-1(3) to be received at the first radio node. The reports may contain information such as raw data or processed data from measurements on and/or processing of the delayed and/or distorted versions of the second signal. Based on the transmitted second signal 30-1 and the received delayed and/or distorted version 35-1 of the second signal and/or the received reports 40-2 and/or 40-3 or 40-1(3), the first radio node may then determine 45 the one or more properties of the object in the environment. For example, the property of the object detected using the first signal can be determined with an improved reliability, accuracy or range of sensing, or another one of the one or more properties of the object can be determined using a reasonable amount of resources based on the detected property of the object detected using the first signal. The one or more properties may e.g. be one or more of presence, location, shape, speed, movement, size and the sensing with the second signal may for example achieve determining presence at a higher reliability than previously obtained with the first signal or determining location of the object with higher accuracy or resolution based on a detected presence of the object using the first signal, or sensing velocity in a wider range using the second signal based on a previous detection of movement of the object using the first signal.

FIG. 7 illustrates a signalling diagram similar to that of FIG. 6, and will therefore not be described in full detail, only the differences will be described here, while referring to FIG. 6 for other details. In FIG. 7, the further node, acting as a sensing controller, may trigger, by signalling 5, the first radio node to transmit the first signal 10. The signalling 5 may be performed by the further node itself in case it is a radio node having radio capability, or it may be done by signalling via a radio node to which the further node is connected e.g. via wire. In comparison, the first radio node as illustrated in FIG. 6 may have been triggered to transmit the first signal by some other means, e.g. by being triggered to do sensing by a wireless device or user equipment. Signalling 15-1, 15-2, 20-2 and 20-1(1) are as described for FIG. 6. A difference in FIG. 7 is that either the first radio node or the further node may detect 25 the property of the object in the environment. In case the detection 25 is performed at the first radio node, the signalling 20-1(2) is as described in relation to FIG. 6, whereas if the detection 25 is performed at the further node, the signalling, denoted 20-1 in FIG. 7, is instead a report of the reception of the delayed and/or distorted version 15-1 of the first signal at the first radio node to the further node, possibly via one of the radio nodes to which the further node is connected e.g. via wire. Information on the transmitted first signal, such as first parameter setting, may in this case either be contained in or sent with the report 20-1 or otherwise known or made known to the further node. As mentioned in relation to FIG. 6 above, the reports may also in this case contain information such as raw data or processed data from measurements on and/or processing of the delayed and/or distorted versions of the first signal. Based on the transmitted first signal 10 and the received reports 20-1 and/or 20-1(1), the further node may then detect 25 the property of the object in the environment.

In FIG. 7, in case the detection 25 is performed at the first radio node, the first radio node will, upon detection of the property of the object, report 30-2 the detected property of the object in the environment to the further node, possibly via one of the radio nodes to which the further node is connected e.g. via wire. The report may for example contain a rough estimation of the detected property, such as a rough estimate of location and/or velocity, as detection of that the object is present and/or moving in the environment. The further node may then, upon detection 25 of the property of the object in the environment, whether performed by the further node or performed and reported 30-2 by the first radio node, trigger, by signalling 50-1, one of the radio nodes, exemplified by the third radio node, to transmit a second signal 30-3 having a second parameter setting for determining one or more properties of the object in the environment using sensing. The signalling 50-1 may be performed by the further node itself in case it is a radio node having radio capability, or it may be done by signalling via a radio node to which the further node is connected e.g. via wire. Upon reception of the trigger, the third radio node transmits the second signal 30-3 in correspondence with the description provided for signalling 30-1 in FIG. 6. The first, second and third radio nodes may then receive signalling 35-1, 35-2 and/or 35-3 as described in relation to FIG. 6. The third node may then receive a report 40-2 of reception of the delayed and/or distorted version 35-2 of the second signal from the second radio node and/or a report 40-1 of reception of the delayed and/or distorted version 35-1 of the second signal from the first radio node. The third radio node may process reported delayed and/or distorted versions of the second signal at different ones of the radio nodes and send a report 40-3 to be received at the further node, possibly via one of the radio nodes to which the further node is connected e.g. via wire. Alternatively, each of the different ones of the radio nodes may send their respective reports of received delayed and/or distorted versions of the second signal directly to the further node, possibly via one of the radio nodes to which the further node is connected e.g. via wire. The reports may contain information such as raw data or processed data from measurements on and/or processing of the delayed and/or distorted versions of the second signal. Based on the transmitted second signal 30-3 and the received report 40-3 from the third radio node or individual reports from each of the different radio nodes, the further node may then determine 45 the one or more properties of the object in the environment in correspondence with description in FIG. 6. Information on the transmitted second signal, such as second parameter setting, may in this case either be contained in or sent with the report 40-3 or otherwise known or made known to the further node. Alternatively, the third radio node may, based on the transmitted second signal 30-3 and the received delayed and/or distorted version 35-3 of the second signal and/or the received reports 40-2 and/or 40-1, determine 45 the one or more properties of the object in the environment, as illustrated in FIG. 7. Information on the the property of the object detected with the first signal, such as a rough estimation of the detected property, may in this case either be contained in or sent with the trigger 50-1 to the third radio node or otherwise provided to the third node. Examples of such determination are as described in relation to FIG. 6. The third node may finally report 50-2 the information on determined one or more properties of the object to the further node, possibly via one of the radio nodes to which the further node is connected e.g. via wire.

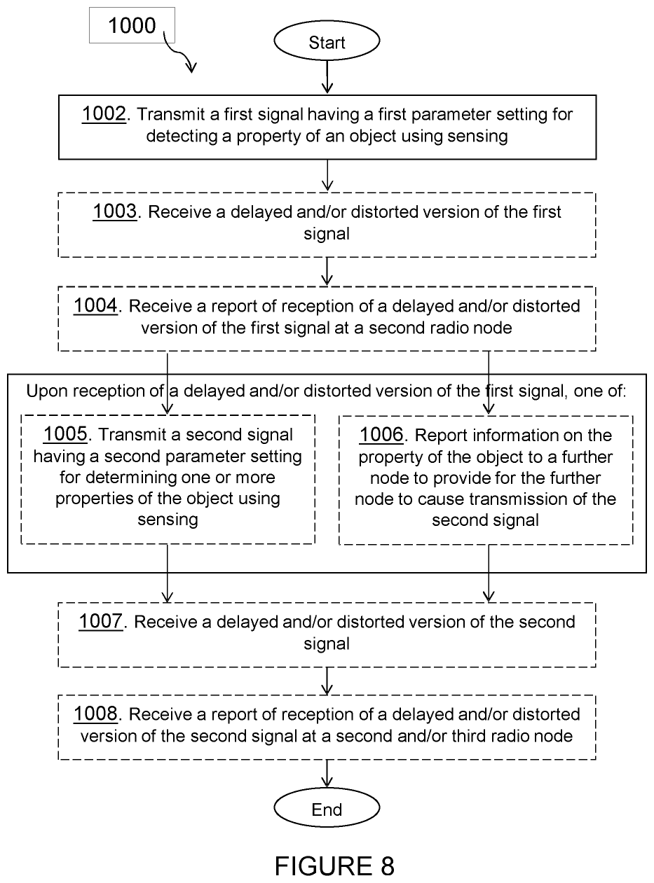

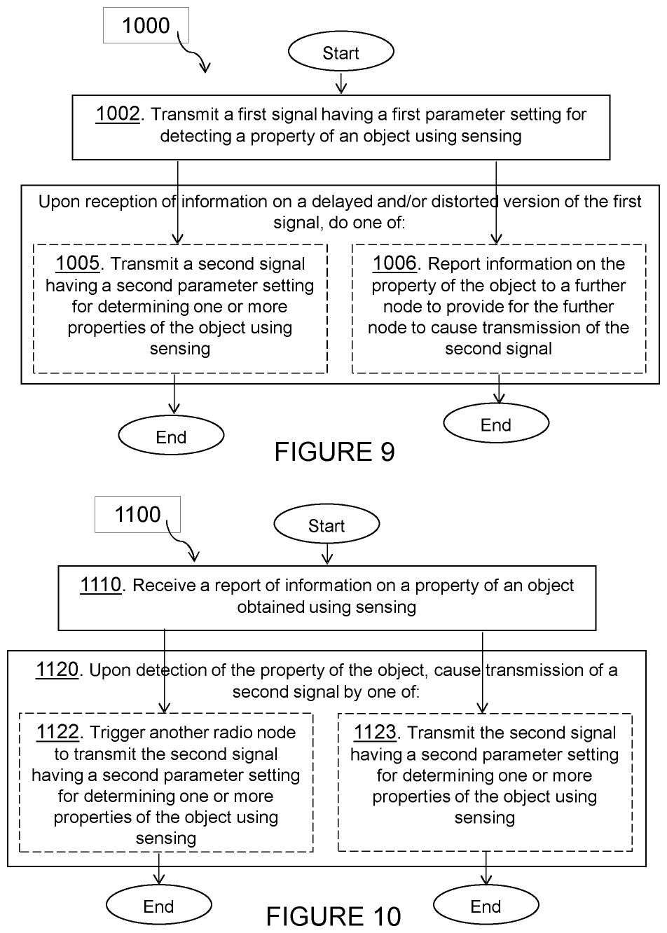

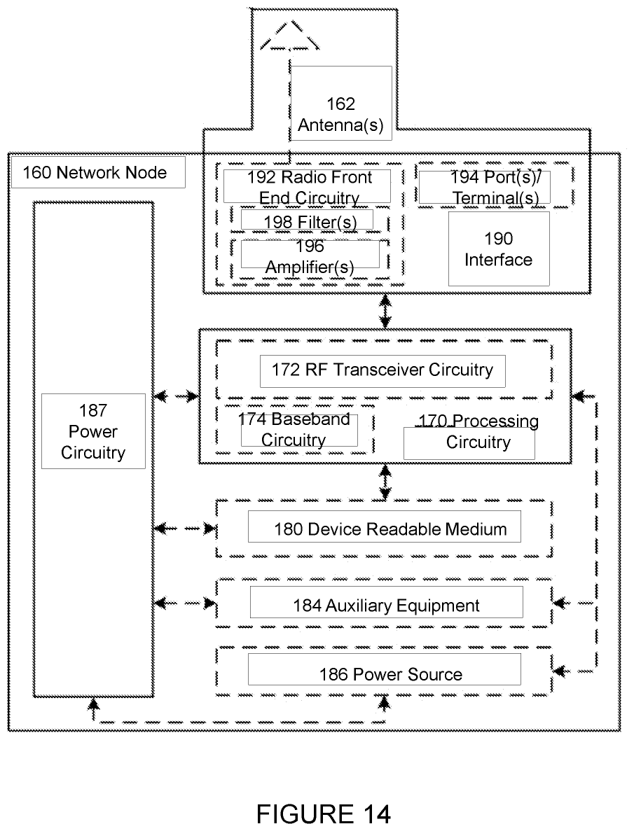

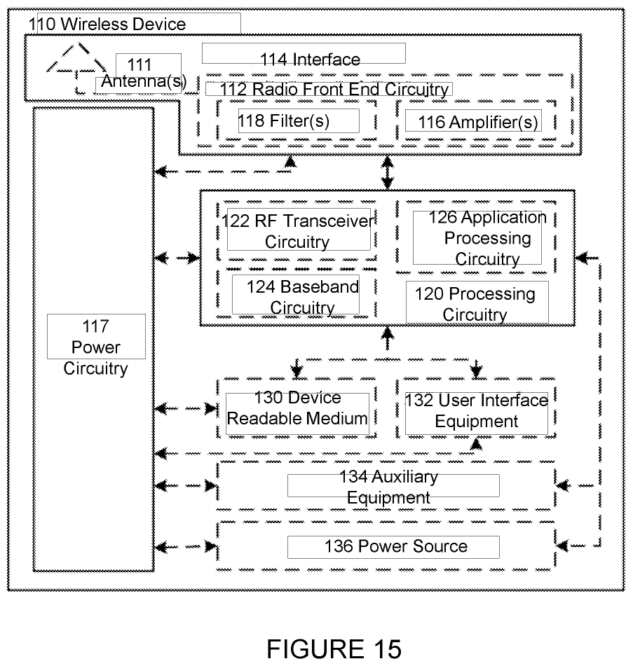

FIGS. 8 and 9 illustrate a method (e.g., procedure) 1000 for handling sensing of an object in an environment served by a wireless communication network employing joint communication and sensing according to various exemplary embodiments of the present disclosure. For example, the method shown in FIGS. 8 and 9 can be performed by or implemented in a first radio node such as a network node having radio capability, wireless device or UE configured as described with reference to FIGS. 14 and 15 herein.

The exemplary method 1000 illustrated in FIG. 8 can include the operations of the following blocks:
1002: The first radio node transmits a first signal having a first parameter setting for detecting a property, e.g. presence and/or movement, of the object in the environment using sensing. This step may correspond to signalling 10 as described with reference to FIGS. 6 and 7 above.
1003: The first radio node may in some embodiments receive a delayed and/or distorted version of the first signal. This may correspond to signalling 15-1 in FIGS. 6 and 7.
1004: The first radio node may in some embodiments receive a report of reception at a second radio node of a delayed and/or distorted version of the first signal. The report may be received from the second radio node or from a further node. This may correspond to signalling 20-2 or 20-1(2) in FIGS. 6 and 7.

In response to having received information on a delayed and/or distorted version of the first signal, as received in step 1003 and/or as reported in step 1004, the first radio node performs one of the steps 1005 and 1006:
1005: The first radio node transmits a second signal having a second parameter setting for determining one or more properties or characteristics of the object in the environment using sensing. This step may be performed in response to the first radio node having detected the property of the object in the environment or in response to the property of the object in the environment being detected by the further node which then triggers the first radio node to transmit the second signal. These alternatives correspond to box 25 and signalling 30-1 in FIG. 6 and to signalling 20-1, box 25 at the further node and signalling 50-1 and 30-3 applied to first node instead of third radio node in FIG. 7.
1006: The first radio node reports information on the property of the object in the environment to the further node to provide for the further node to cause transmission of the second signal having the second parameter setting for determining the one or more properties or characteristics of the object in the environment using sensing. This step may be performed in response to the first radio node having detected the property of the object in the environment and corresponds to box 25 at the first radio node and signalling 30-2 in FIG. 7.
1007: The first radio node may in some embodiments receive a delayed and/or distorted version of the second signal. This may correspond to signalling 15-1 in FIGS. 6 and 7.
1008: The first radio node may in some embodiments receive a delayed and/or distorted version of the second signal. The report may be received from the second and/or a third radio node or from the further node. This may correspond to signalling 40-2, 40-3 and 40-1(3) in FIG. 6. As illustrated by box 45 in FIG. 6, the first radio node may then determine one or more properties of the object in the environment. In other embodiments, as illustrated by the third radio node being the receiver of reports 40-2 and 40-1 in FIG. 7, the radio node receiving reports from other radio nodes may report to the further node and the further node may then determine one or more properties of the object in the environment, as illustrated by signalling 40-3 and box 45 at the further node in FIG. 7.

In the method 1000, the second parameter setting applied for the second signal provides for sensing at a higher resolution and/or in a wider range and/or with higher reliability than the first parameter setting applied for the first signal. For example, the second parameter setting may provide for sensing at a higher resolution and/or in a wider range and/or with higher reliability with respect to at least one metric of the one or more properties.

FIG. 9 depicts a more condensed version of the method 1000, showing only steps that are needed to bring about the inventive effect of the method. The method includes the operations of the following blocks:
1002: The first radio node transmits a first signal having a first parameter setting for detecting a property, e.g. presence and/or movement, of the object in the environment using sensing. This step may correspond to signalling 10 as described with reference to FIGS. 6 and 7 above.

Upon reception of information on a delayed and/or distorted version of the first signal and/or upon detection of the property of the object in the embodiment, the first radio node performs one of the steps 1005 and 1006:
1005: The first radio node transmits a second signal having a second parameter setting for determining one or more properties or characteristics of the object in the environment using sensing. This step may be performed in response to the first radio node having detected the property of the object in the environment or in response to the property of the object in the environment being detected by the further node which then triggers the first radio node to transmit the second signal.
1006: The first radio node reports information on the property of the object in the environment to the further node to provide for the further node to cause transmission of the second signal having the second parameter setting for determining the one or more properties or characteristics of the object in the environment using sensing. This step may be performed in response to the first radio node having detected the property of the object in the environment.

As stated above in relation to FIG. 8, the second parameter setting applied for the second signal in the method 1000 provides for sensing at a higher resolution and/or in a wider range and/or with higher reliability than the first parameter setting applied for the first signal.

FIG. 10 illustrates a method 1100 (e.g., procedure) for handling sensing of an object in an environment served by a wireless communication network employing joint communication and sensing according to various exemplary embodiments of the present disclosure. For example, the method 1100 shown in FIG. 10 can be performed by or implemented in a further node, which may be a network node, a network node having radio capability, wireless device or UE configured as described with reference to FIGS. 14 and 15 herein.

The exemplary method 1100 illustrated in FIG. 10 can include the operations of the following blocks:
1110: The further node receives a report of information on a property of the object in the environment, the information on the property being obtained using sensing, the sensing including a first radio node transmitting a first signal having a first parameter setting for detecting the property, e.g. presence and/or movement, of the object in the environment. The report may for example be received from the first radio node. The report may be received in response to the first radio node having detected the property of the object in the environment or it may be received to provide the information on the property of the object that enables the property of the object in the environment to be detected by the further node. The report may contain information that the property of the object is detected in the environment, e.g. by a rough estimate of location and/or velocity as indication that the object is present and/or moving in the environment, or it may contain information such as raw data or processed data from measurements on and/or processing of the delayed and/or distorted versions of the first signal and possibly also information on the transmitted first signal, such as first parameter setting, depending on whether the first radio node or the further node performs the detection. This step may correspond to signalling 20-1 and 20-1(1) or to signalling 30-2 as described with reference to FIG. 7 above.
1120: Upon detection of the property of the object in the embodiment, the further node causes transmission of a second signal having a second parameter setting for determining one or more properties or characteristics of the object in the environment using sensing. This step may correspond to signalling 50-1 and 30-3 as described with reference to FIG. 7 above. The further node may cause the transmission of step 1120 by performing one of the steps 1122 and 1123:
1122: The further node may trigger a radio node to transmit the second signal;
1123: The further node may be a radio node that transmits the second signal;

In the method 1100, the second parameter setting applied for the second signal provides for sensing at a higher resolution and/or in a wider range and/or with higher reliability than the first parameter setting applied for the first signal. For example, the second parameter setting may provide for sensing at a higher resolution and/or in a wider range and/or with higher reliability with respect to at least one metric of the one or more properties.

In some embodiments of methods 1000 and 1100, the first and second parameter settings may comprise respective settings of bandwidth for the first and second signals, and the bandwidth of the first signal may be a fraction of the bandwidth of the second signal. In one example, the bandwidth of the first signal may be a tenth of the bandwidth of the second signal.

Alternatively or additionally, the first and second parameter settings may comprise respective settings of beamwidth for the first and second signals. In one example, the beamwidth of the first signal may be wider than the beamwidth of the second signal.

Alternatively or additionally, the first and second parameter settings may comprise respective settings of periodicity for the first and second signals. In one example, the periodicity of the first signal is longer than the periodicity of the second signal.

Alternatively or additionally, a combination of different signals e.g. of different reference signals, used for communication in the wireless communication network may be re-used as the first and second signals for the sensing of the object in the environment. In one example, downlink synchronization signal(s) may be re-used as the first signal and downlink positioning reference signal(s) as the second signals for the sensing of the object in the environment. In an alternative the second signal is a signal dedicated for the sensing whereas the first signal may still be a re-used signal, such as downlink synchronization signal(s).

Alternatively or additionally, a combination of downlink, DL, and uplink, UL, signals used for communication in the wireless communication network may be re-used as the first and second signals for the sensing of the object in the environment. In one example, downlink synchronization signal(s) may be re-used as the first signal and downlink positioning reference signal(s) as the second signals for the sensing of the object in the environment. In this case different nodes may be cooperating by one node, e.g. the first radio node, transmitting DL positioning reference signal (PRS) or DL synchronization signal as the first signal and another node, e.g. the third radio node, transmitting UL SRS as the second signal.

In some example embodiments of the methods 1000 and 1100, the detected property may include presence of the object in the environment and the sensing may be repeatedly performed with the first signal until a presence condition, e.g. presence within closer range, such as range below a threshold is met and sensing with the second signal is triggered.

In these and other example embodiments of the methods 1000 and 1100, the detected property may include movement of the object in the environment and the sensing may be repeatedly performed with the first signal until a movement condition, e.g. movement at higher speed, such as speed above a threshold, is met and sensing with the second signal is triggered.

In these and other example embodiments of the methods 1000 and 1100, the higher resolution and/or wider range and/or higher reliability provided for by the second parameter setting applied to or for the second signal is with respect to at least one metric of the one or more properties, the at least one metric being one or more of: unambiguous range of location or presence of the object, range resolution or angular resolution of location or presence of the object, unambiguous velocity or velocity range of movement of the object, and velocity resolution range of movement of the object.

In these and other example embodiments of the methods 1000 and 1100, the sensing using the second signal may be performed to determine the property of the object detected in the sensing using the first signal at higher resolution and/or wider range and/or higher reliability with respect to a metric of the property of the object as compared to the resolution and/or range and/or reliability obtained in the sensing of the object using the first signal.

Alternatively or additionally, the sensing using the second signal may be performed to determine at least one property other than the property of the object detected in the sensing using the first signal.

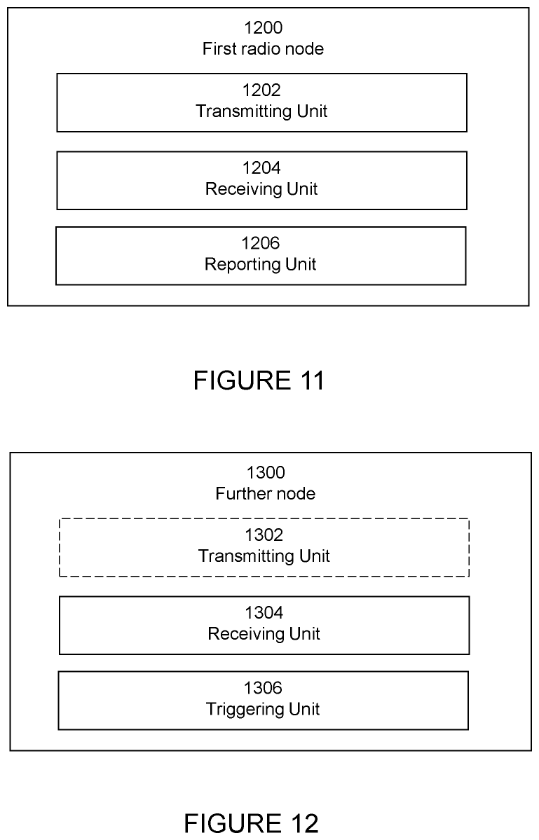

FIG. 11 illustrates a first radio node 1200 configured to carry out any of the methods 1000 presented herein for handling sensing of an object in an environment served by a wireless communication network employing joint communication and sensing. The first radio node 1200 may be any node capable of transmitting radio signals. For example, it may be implemented by a network node 160 as illustrated in FIG. 14 or by a wireless device 110 as illustrated in FIG. 15.

The first radio node 1200 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause transmitting unit 1202, receiving unit 1204, reporting unit 1206, and any other suitable units of the first radio node 1200 to perform corresponding functions according one or more embodiments of the present disclosure.

As illustrated in FIG. 11, the first radio node 1200 includes transmitting unit 1202 configured to transmit a first signal having a first parameter setting for detecting a property, e.g. presence and/or movement, of the object in the environment using sensing. The transmitting unit 1202 may further be configured to, upon reception of information on a delayed and/or distorted version of the first signal, as one alternative, transmit a second signal having a second parameter setting for determining one or more properties or characteristics of the object in the environment using sensing. The first radio node 1200 further includes a reporting unit 1206 configured to, upon reception of information on a delayed and/or distorted version of the first signal, as another alternative, report information on the property of the object in the environment to a further node to provide for the further node to cause transmission of the second signal having the second parameter setting for determining the one or more properties or characteristics of the object in the environment using sensing. The first radio node 1200 may further include a receiving unit 1204 configured to receive the delayed and/or distorted version of the first signal and/or configured to receive a report of reception at a second radio node of the delayed and/or distorted version of the first signal. The receiving unit 1204 may further be configured to receive a delayed and/or distorted version of the second signal and/or configured to receive a report of reception at the second radio node and/or at a third radio node of a delayed and/or distorted version of the second signal. The first radio node 1200 being configured to apply the second parameter setting for the second signal provides for sensing at a higher resolution and/or in a wider range and/or with higher reliability than with the first parameter setting that the first radio node is configured to apply for the first signal. The sensing at a higher resolution and/or in a wider range and/or with higher reliability may for example be provided with respect to at least one metric of the one or more properties.

FIG. 12 illustrates a further node 1300 configured to carry out any of the methods 1100 presented herein for handling sensing of an object in an environment served by a wireless communication network employing joint communication and sensing. The further node 1300 may be any node capable of communication. For example, it may be implemented by radio node capable of radio communication or by a network node having an interface for wired communication. It may also be implemented by a network node 160 as illustrated in FIG. 14 or by a wireless device 110 as illustrated in FIG. 15.

The further node 1300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause transmitting unit 1302, receiving unit 1304, triggering unit 1306, and any other suitable units of the further node 1300 to perform corresponding functions according one or more embodiments of the present disclosure.

As illustrated in FIG. 12, the further node 1300 includes receiving unit 1304 configured to receive a report of information on detection of a property of the object in the environment, the information on property being obtained using sensing, the sensing including a first radio node transmitting a first signal having a first parameter setting for detecting the property, e.g. presence and/or movement, of the object in the environment. The further node 1300 further includes a triggering unit 1306. The further node 1300 is configured to, upon detection of the property of the object in the environment, cause transmission of a second signal having a second parameter setting for determining one or more properties of the object in the environment using sensing. The further node 1300 may be configured to cause the transmission by the triggering unit 1306 being configured to trigger a radio node to transmit the second signal or by the further node 1300 being a radio node including transmitting unit 1302 being configured to transmit the second signal. The second parameter setting being applied for the second signal provides for sensing at a higher resolution and/or in a wider range and/or with higher reliability than the first parameter setting that is applied for the first signal. The sensing at a higher resolution and/or in a wider range and/or with higher reliability may for example be provided with respect to at least one metric of the one or more properties.

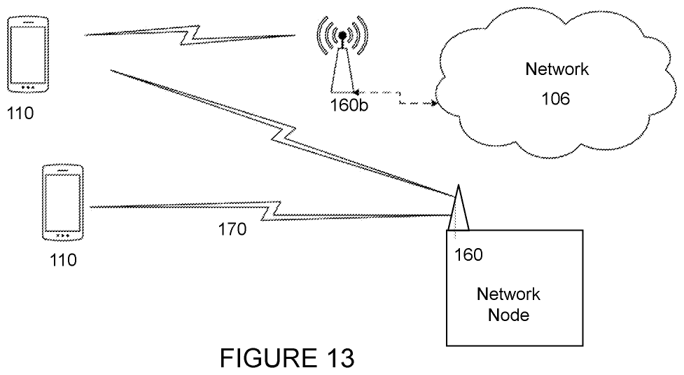

Although the methods for handling sensing of an object in an environment served by a wireless communication network employing joint communication and sensing described herein may be implemented in any appropriate type of system using any suitable components, the embodiments disclosed herein are described in relation to a wireless communication network, such as the example wireless communication network illustrated in FIG. 13. For simplicity, the wireless communication network of FIG. 13 only depicts network 106, network nodes 160 and 160b, and wireless devices (WDs) 110. In practice, a wireless communication network may further include any additional elements suitable to support communication between wireless devices or between a wireless device and another communication device, such as a landline telephone, a service provider, or any other network node or end device. Of the illustrated components, network node 160 and WD 110 are depicted with additional detail. The wireless communication network may provide communication and other types of services to one or more wireless devices to facilitate the wireless devices' access to and/or use of the services provided by, or via, the wireless communication network.

The wireless communication network may comprise and/or interface with any type of communication, telecommunication, data, cellular, and/or radio network or other similar type of system. In some embodiments, the wireless communication network may be configured to operate according to specific standards or other types of predefined rules or procedures. Thus, particular embodiments of the wireless communication network may implement communication standards, such as Global System for Mobile Communications (GSM), Universal Mobile Telecommunications System (UMTS), Long Term Evolution (LTE), New Radio (NR), evolved NR or 6G, and/or other suitable current or future 3GPP standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless communication networks, metropolitan area networks, and other networks to enable communication between devices.

Network node 160 and WD 110 comprise various components described in more detail below. These components work together in order to provide network node and/or wireless device functionality, such as providing wireless connections in a wireless communication network. In different embodiments, the wireless communication network may comprise any number of wired or wireless communication networks, network nodes, base stations, controllers, wireless devices, relay stations, and/or any other components or systems that may facilitate or participate in the communication of data and/or signals whether via wired or wireless connections.

FIG. 14 illustrates an example network node 160, according to certain embodiments. As used herein, network node refers to equipment capable, configured, arranged and/or operable to communicate directly or indirectly with a wireless device and/or with other network nodes or equipment in the wireless communication network to enable and/or provide wireless access to the wireless device and/or to perform other functions (e.g., administration) in the wireless communication network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., Mobile Switching Centers (MSCs), Mobility Management Entities (MMEs)), Operations & Maintenance (O&M) nodes, Operations Support System (OSS) nodes, Self-Organizing Network (SON) nodes, positioning nodes (e.g., Evolved-Serving Mobile Location Centres (E-SMLCs)), and/or Minimization of Drive Tests (MDTs). As another example, a network node may be a virtual network node as described in more detail below. More generally, however, network nodes may represent any suitable device (or group of devices) capable, configured, arranged, and/or operable to enable and/or provide a wireless device with access to the wireless communication network or to provide some service to a wireless device that has accessed the wireless communication network.

In FIG. 14, network node 160 includes processing circuitry 170, device readable medium 180, interface 190, auxiliary equipment 184, power source 186, power circuitry 187, and antenna 162. Although network node 160 illustrated in FIGS. 13 and 14 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, 6G, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless communication network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 14 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

FIG. 15 illustrates an example WD 110, according to certain embodiments. As used herein, WD refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, WD 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120, and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless communication network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless communication network, and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

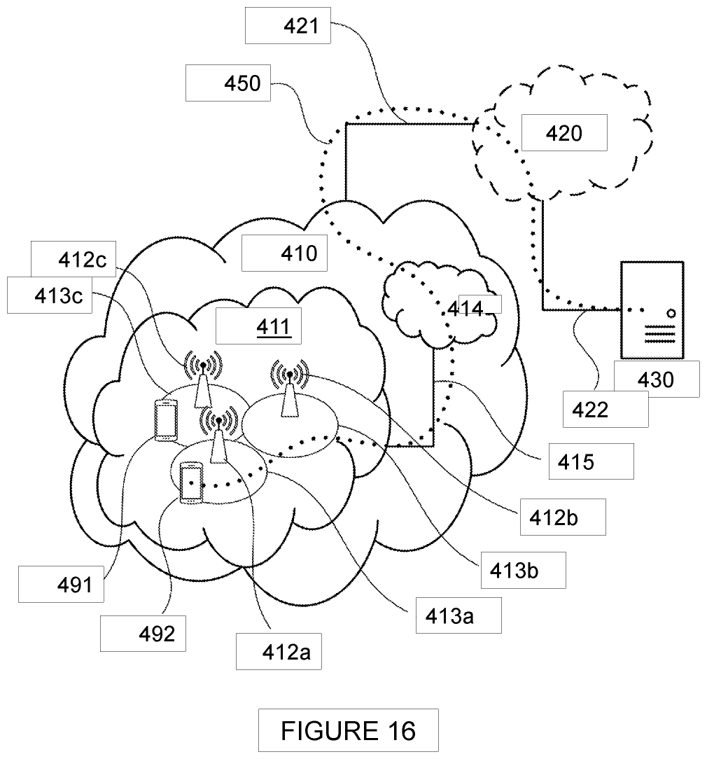

FIG. 16 illustrates an example communication system that includes telecommunication network 410, such as a 3GPP-type cellular network, which comprises access network 411, such as a radio access network, and core network 414, according to certain embodiments. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 16 as a whole enables connectivity between the connected UEs 491, 492 and host computer 430. The connectivity may be described as an over-the-top (OTT) connection 450. Host computer 430 and the connected UEs 491, 492 are configured to communicate data and/or signalling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

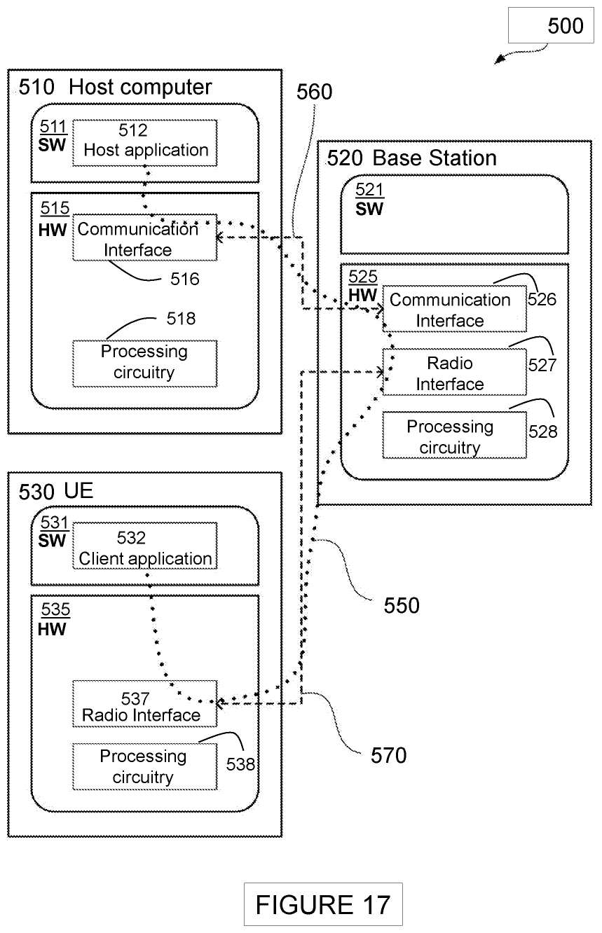

Example implementations, in accordance with an embodiment, of the UE, base station and host computer discussed in the preceding paragraphs will now be described with reference to FIG. 17. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 17) served by base station 520. Communication interface 526 may be configured to facilitate connection 560 to host computer 510. Connection 560 may be direct or it may pass through a core network (not shown in FIG. 17) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 17 may be similar or identical to host computer 430, one of base stations 412a, 412b, 412c and one of UEs 491, 492 of FIG. 16, respectively. This is to say, the inner workings of these entities may be as shown in FIG. 17 and independently, the surrounding network topology may be that of FIG. 16.

In FIG. 17, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the data rate, latency or power consumption and thereby provide benefits such as reduced user waiting time, relaxed restriction on file size, better responsiveness, or extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing, etc. The reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

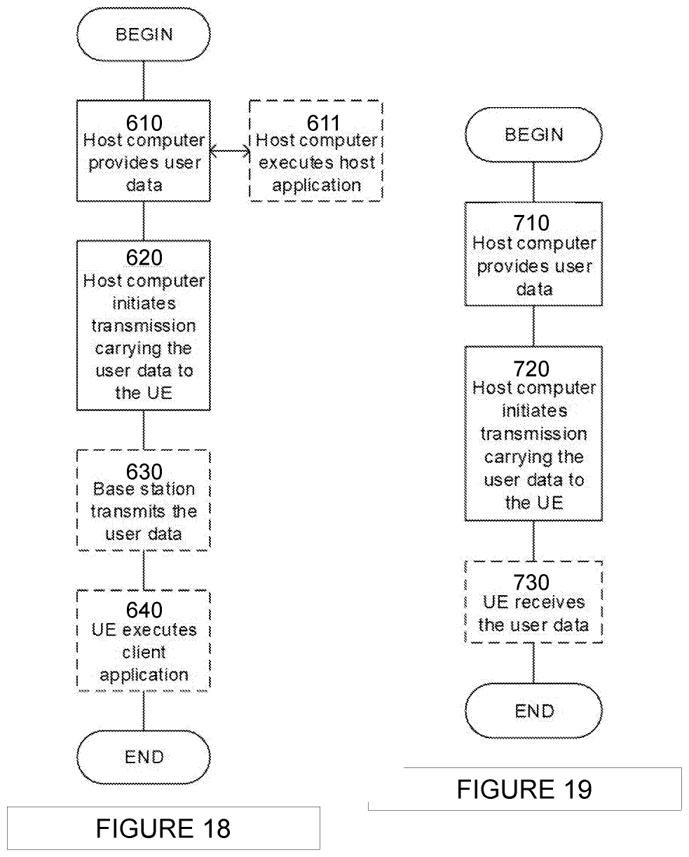

FIG. 18 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 18 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 19 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 19 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

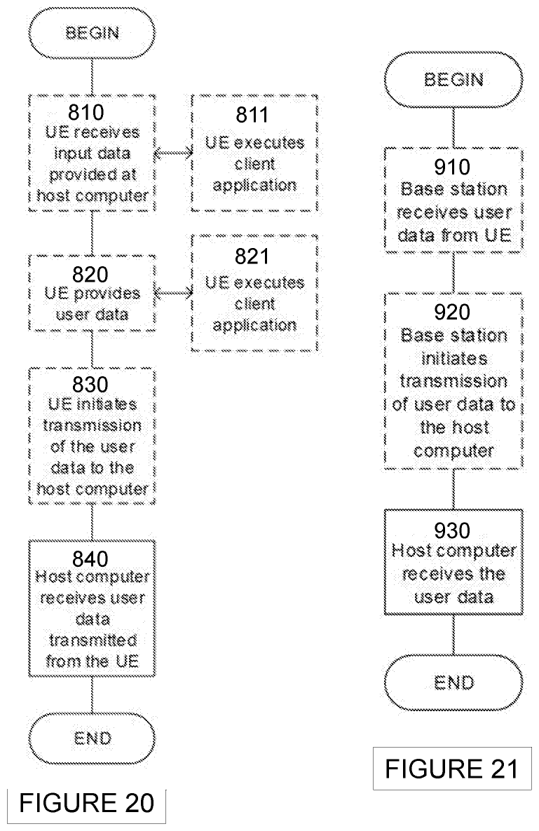

FIG. 20 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 20 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 21 is a flowchart illustrating an example method implemented in a communication system, in accordance with one embodiment. The communication system includes a host computer, a base station and a UE which may be those described with reference to FIGS. 16 and 17. For simplicity of the present disclosure, only drawing references to FIG. 21 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

Steps, whether explicitly referred to a such or if implicit, may be re-ordered or omitted if not essential to some of the disclosed embodiments. Like numbers in the drawings refer to like elements throughout.

The terminology used herein is for the purpose of describing particular aspects of the disclosure only, and is not intended to limit the disclosed technology embodiments described herein. As used herein, the singular forms “a”, “an” and “the” are intended to include the plural forms as well, unless the context clearly indicates otherwise.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

It should be noted that although some terminology from 3GPP LTE, 5G and 6G standards related technology has been used herein to explain the example embodiments, this should not be seen as limiting the scope of the example embodiments to only these aforementioned communication systems. Other wireless systems may also benefit from the example embodiments disclosed herein.

Also note that terminology such as eNodeB and wireless communications device should be considered as non-limiting and does in particular not imply a certain hierarchical relation between the two. In general “eNodeB” could be considered as device 1 and “wireless communications device” as device 2, and these two devices communicate with each other over some radio channel. Furthermore, while the example embodiments focus on wireless transmissions in the uplink, it should be appreciated that the example embodiments could be applicable in the downlink.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements, features, functions, or steps than those listed and the words “a” or “an” preceding an element do not exclude the presence of a plurality of such elements, features, functions, or steps. It should further be noted that any reference signs do not limit the scope of the claims, that the example embodiments may be implemented at least in part by means of both hardware and software, and that several “means”, “units” or “devices” may be represented by the same item of hardware.

A “wireless communications device” as the term may be used herein, is to be broadly interpreted to include a radiotelephone having ability for Internet/intranet access, web browser, organizer, calendar, a camera (e.g., video and/or still image camera), a sound recorder (e.g., a microphone), and/or global positioning system (GPS) receiver; a personal communications system (PCS) user equipment that may combine a cellular radiotelephone with data processing; a personal digital assistant (PDA) that can include a radiotelephone or wireless communication system; a laptop; a camera (e.g., video and/or still image camera) having communication ability; and any other computation or communication device capable of transcribing, such as a personal computer, a home entertainment system, a television, etc. Furthermore, a device may be interpreted as any number of antennas or antenna elements.

Where the description refers to “user equipment” this is to be considered a non-limiting term which means any wireless communications device, terminal, or node capable of receiving in DL and transmitting in UL (e.g. PDA, laptop, mobile, sensor, fixed relay, mobile relay or even a radio base station, e.g. femto base station), which may or may not be always used or useable by a human user, for example UE may be used by a machine user in some embodiments.

A cell is associated with a radio node, where a radio node or radio network node or eNodeB used interchangeably in the example embodiment description, comprises in a general sense any node transmitting radio signals used for measurements, e.g., eNodeB, macro/micro/pico base station, home eNodeB, relay, beacon device, or repeater. A radio node herein may comprise a radio node operating in one or more frequencies or frequency bands. It may be a radio node capable of CA. It may also be a single-or multi-RAT node. A multi-RAT node may comprise a node with co-located RATs or supporting multi-standard radio (MSR) or a mixed radio node.

The various example embodiments described herein are described in the general context of methods, and may refer to elements, functions, steps or processes, one or more or all of which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1-22. (canceled)

23. A method performed by a first radio node for handling sensing of an object in an environment served by a wireless communication network employing joint communication and sensing, the method comprising:
transmitting a first signal having a first parameter setting for detecting a property of the object in the environment using sensing; and
upon reception of information on a delayed and/or distorted version of the first signal:
transmitting a second signal having a second parameter setting for determining one or more properties of the object in the environment using sensing; or
reporting information on the property of the object in the environment to a further node to provide for the further node to cause transmission of the second signal having the second parameter setting for determining the one or more properties of the object in the environment using sensing;
wherein the second parameter setting applied for the second signal provides for sensing at a higher resolution and/or in a wider range and/or with higher reliability than the first parameter setting applied for the first signal.

24. The method according to claim 23, wherein the method further includes:
receiving a delayed and/or distorted version of the first signal; and/or
receiving a report of reception at a second radio node of a delayed and/or distorted version of the first signal.

25. The method according to claim 23, wherein the method further includes:
receiving a delayed and/or distorted version of the second signal; and/or
receiving a report of reception at the second and/or a third radio node of a delayed and/or distorted version of the second signal.

26. A method performed by a further node for handling sensing of an object in an environment served by a wireless communication network employing joint communication and sensing, the method comprising:
receiving a report of information on a property of the object in the environment, the information on the property being obtained using sensing, the sensing including a first radio node transmitting a first signal having a first parameter setting for detecting the property of the object in the environment; and
upon detection of the property of the object in the environment:
causing transmission of a second signal having a second parameter setting for determining one or more properties of the object in the environment using sensing;
wherein the second parameter setting applied for the second signal provides for sensing at a higher resolution and/or in a wider range and/or with higher reliability than the first parameter setting applied for the first signal.

27. The method according to claim 26, wherein the causing transmission of the second signal includes:
triggering a radio node to transmit the second signal; or
transmitting, by the further node being a radio node, the second signal.

28. The method according to claim 26, wherein the first and second parameter settings comprise a respective setting of bandwidth for the first and second signals, and wherein the bandwidth of the first signal is a fraction of the bandwidth of the second signal.

29. The method according to claim 26, wherein the first and second parameter settings comprise a respective setting of beamwidth for the first and second signals, and wherein the beamwidth of the first signal is wider than the beamwidth of the second signal.

30. The method according to claim 26, wherein the first and second parameter settings comprise a respective setting of periodicity for the first and second signals, and wherein the periodicity of the first signal is longer than the periodicity of the second signal.

31. The method according to claim 26, wherein a combination of different signals reference used for communication in the wireless communication network are re-used as the first and second signals for the sensing of the object in the environment.

32. The method according to claim 26, wherein a combination of downlink (DL) and uplink (UL) signals used for communication in the wireless communication network are re-used as the first and second signals for the sensing of the object in the environment.

33. The method according to claim 26, wherein the detected property is presence of the object in the environment and wherein the sensing is repeatedly performed with the first signal until a presence condition is met and sensing with the second signal is triggered.

34. The method according to claim 26, wherein the detected property is movement of the object in the environment and wherein the sensing is repeatedly performed with the first signal until a movement condition is met and sensing with the second signal is triggered.

35. The method according to claim 26, wherein the higher resolution and/or wider range and/or higher reliability provided for by the second parameter setting applied for the second signal is with respect to at least one metric of the one or more properties, the at least one metric being one or more of: unambiguous range of location or presence of the object, range resolution or angular resolution of location or presence of the object, unambiguous velocity of movement of the object, and velocity resolution range of movement of the object.

36. The method according to claim 26, wherein the sensing using the second signal is performed to determine the property of the object detected in the sensing using the first signal at higher resolution and/or wider range and/or higher reliability with respect to a metric of the property of the object as compared to the resolution and/or range and/or reliability obtained in the sensing of the object using the first signal.

37. The method according to claim 26, wherein the sensing using the second signal is performed to determine at least one property other than the property of the object detected in the sensing using the first signal.

38. A first radio node for handling sensing of an object in an environment served by a wireless communication network employing joint communication and sensing, the first radio node comprising:
a transmitter; and
processing circuitry configured to:
transmit, via the transmitter, a first signal having a first parameter setting for detecting a property of the object in the environment using sensing; and
upon reception of information on a delayed and/or distorted version of the first signal:
transmit a second signal having a second parameter setting for determining one or more properties of the object in the environment using sensing; or
report information on the property of the object in the environment to further node to provide for the further node to cause transmission of the second signal having the second parameter setting for determining the one or more properties of the object in the environment using sensing;
wherein the second parameter setting applied for the second signal provides for sensing at a higher resolution and/or in a wider range and/or with higher reliability than the first parameter setting applied for the first signal.

39. The first radio node according to claim 38, wherein the processing circuitry is further configured: receive, via a receiver of the first radio node, a delayed and/or distorted version of the first signal, and/or receive a report of reception at a second radio node of a delayed and/or distorted version of the first signal.

40. The first radio node according to claim 38, wherein the processing circuitry is configured to receive, via a receiver of the first radio node, a delayed and/or distorted version of the second signal, and/or receive a report of reception at the second and/or a third radio node of a delayed and/or distorted version of the second signal.

41. A further node for handling sensing of an object in an environment served by a wireless communication network employing joint communication and sensing, the further node comprising:
a receiver; and
processing circuitry configured to:
receive, via the receiver, a report of information on detection of a property of the object in the environment, the information on the property being detected using sensing, the sensing including a first radio node transmitting a first signal having a first parameter setting for detecting the property of the object in the environment; and
upon detection of the property of the object in the environment:
cause transmission of a second signal having a second parameter setting for determining one or more properties of the object in the environment using sensing;
wherein the second parameter setting applied for the second signal provides for sensing at a higher resolution and/or in a wider range and/or with higher reliability than the first parameter setting applied for the first signal.
